(19) United States
(12) Patent Application Publication
(10) Pub. No.: US 2017/0043720 A1
(43) Pub. Date: Feb. 16, 2017

(54) CAMERA SYSTEM FOR DISPLAYING AN AREA EXTERIOR TO A VEHICLE

(71) Applicant: Faraday&Future Inc., Gardena, CA (US)

(72) Inventor: Hamed SHAW, Sunnyvale, CA (US)

(73) Assignee: Faraday&Future Inc., Gardena, CA (US)

(21) Appl. No.: 14/871,914

(22) Filed: Sep. 30, 2015

Related U.S. Application Data
(60) Provisional application No. 62/205,558, filed on Aug. 14, 2015.

(51) Int. Cl. B60R 1/00; B60Q 1/26; B60R 11/04; B60Q 1/34; H04N 7/18; G06K 9/00

(52) U.S. Cl. CPC B60R 1/002; H04N 7/181; G06K 9/00791; B60R 11/04; B60Q 1/34; B60Q 1/2661; B60R 2300/8046; B60R 2300/602; B60R 2300/101; B60R 2011/004

(57) ABSTRACT

A camera system for a vehicle may include a manual control configured to receive an input from an occupant indicative of a vehicle operation and responsively generate a signal. The camera system may also include a turn signal configured to illuminate and a camera configured to capture video of an area exterior to the vehicle. The camera system may further include a display configured to display video, and a controller configured to receive the signal from the manual control, actuate the turn signal to illuminate based on the signal, actuate the camera to capture a video based on the signal, and output the video to the display based on the signal.

### CROSS REFERENCE TO RELATED APPLICATION

This application claims the benefit of priority based on U.S. Provisional Patent Application No. 62/205,558 filed on Aug. 14, 2015, the entire disclosure of which is incorporated by reference.

### TECHNICAL FIELD

The present disclosure relates generally to a camera system for a vehicle, and more particularly, to a camera system for displaying an area exterior to a vehicle.

### BACKGROUND

Accidents have often occurred while a vehicle is changing lanes because the driver's limited view of surrounding areas. Most vehicles are equipped with rear and side-view mirrors to provide the driver visibility of areas behind and adjacent the vehicle. However, the mirrors are not ideal because the sharp viewing angles from the driver seat inherently create “blind spots” not visible to the driver via the mirrors. This tends to necessitate the driver to look over the driver's shoulder to view the blind spots prior to changing lanes, which reduces the driver's awareness of the road ahead. Furthermore, the blind spot may even be obstructed because of modern styles favoring smaller windows and sharper design angles.

Vehicle designers have attempted to increase the driver's viewing area by supplementing substantially planar rear and/or side-view mirrors with fish-eye convex mirrors. However, by their very nature, the fish-eye mirrors compress the image and substantially distort the distances between objects. Furthermore, the eyes of the driver must adjust when passing from a planar mirror to a fish-eye mirror. Therefore, the combination of mirrors may confuse the driver, which is especially problematic at highway speeds. The mirrors may also mislead the driver into believing that there is room to change lanes when there is not.

The disclosed camera system is directed to mitigating or overcoming one or more of the problems set forth above and/or other problems in the prior art.

### SUMMARY

One aspect of the present disclosure is directed to a camera system for a vehicle. The camera system may include a manual control configured to receive a first input from an occupant indicative of a first vehicle operation and responsively generate a first signal. The camera system may also include a first turn signal configured to illuminate, and a first camera configured to capture video of a first area exterior to the vehicle. The camera system may further include a display configured to display video, and a controller in communication with the manual control, the first turn signal, the first camera, and the display. The controller may be configured to receive the first signal from the manual control, actuate the first turn signal to illuminate based on the first signal, actuate the first camera to capture a first video based on the first signal, and output the first video to the display based on the first signal.

Another aspect of the present disclosure is directed to a method of displaying an area exterior to a vehicle. The method may include receiving a first input with a manual control indicative of a first vehicle operation and responsively generating a first signal. The method may also include actuating a first turn signal based on the first signal, actuating a first camera to capture a first video of a first area exterior to the vehicle based on the first signal, and outputting the first video to the display based on the first signal.

Yet another aspect of the present disclosure is directed to a vehicle configured to be operated by an occupant. The camera system may include a manual control configured to receive an input from the occupant indicative of a vehicle operation and responsively generate a signal. The camera system may also include a turn signal configured to illuminate, and a camera configured to capture video of an area exterior to the vehicle. The camera system may further include a display configured to display video, and a controller in communication with the manual control, the turn signal, the camera, and the display. The controller may be configured to receive the signal from the manual control, actuate the turn signal based on the signal, actuate the camera to capture a first video based on the signal, and output the video to the display based on the signal.

Still another aspect of the present disclosure is directed to a non-transitory computer-readable medium storing instructions which, when executed, cause one or more processors to perform a method of displaying an area exterior to a vehicle. The method may include receiving an input with a manual control indicative of a vehicle operation and responsively generating a signal. The method may also include actuating a turn signal based on the signal, actuating a camera to capture a video of an area exterior to the vehicle based on the signal, and outputting the video to the display based on the signal.

### BRIEF DESCRIPTION OF THE DRAWINGS

FIG. 1 is a diagrammatic overhead illustration of an exemplary embodiment of a vehicle;

FIG. 2 is a diagrammatic illustration of an exemplary embodiment of an interior of the exemplary vehicle of FIG. 1;

FIG. 3 is a block diagram of an exemplary embodiment of a camera system that may be used with the exemplary vehicle of FIGS. 1 and 2; and

FIG. 4 is a flowchart illustrating an exemplary process that may be performed by the exemplary camera system of FIG. 3.

### DETAILED DESCRIPTION

The disclosure is generally directed to a camera system, which may be integrated into a vehicle. The camera system may include one or more cameras positioned, for example, on top of each side-view mirror. In some embodiments, when the driver actuates a manual control in an attempt to change lanes, at least one of the cameras may activate and record the rear side-view of the vehicle. This recording may be projected instantaneously on a head-up display either on a left side (if the driver actuates a left signal) or on a right side (if the driver actuates a right signal). The disclosed camera system may provide a two-fold advantage that increases driver safety. First, the system may provide a video and/or an image of the rear side-view of the vehicle, without requiring the driver to substantially redirect the driver's sightline. Second, the video and/or image may provide the driver a view of any blind spots that are not reflected in the mirror.

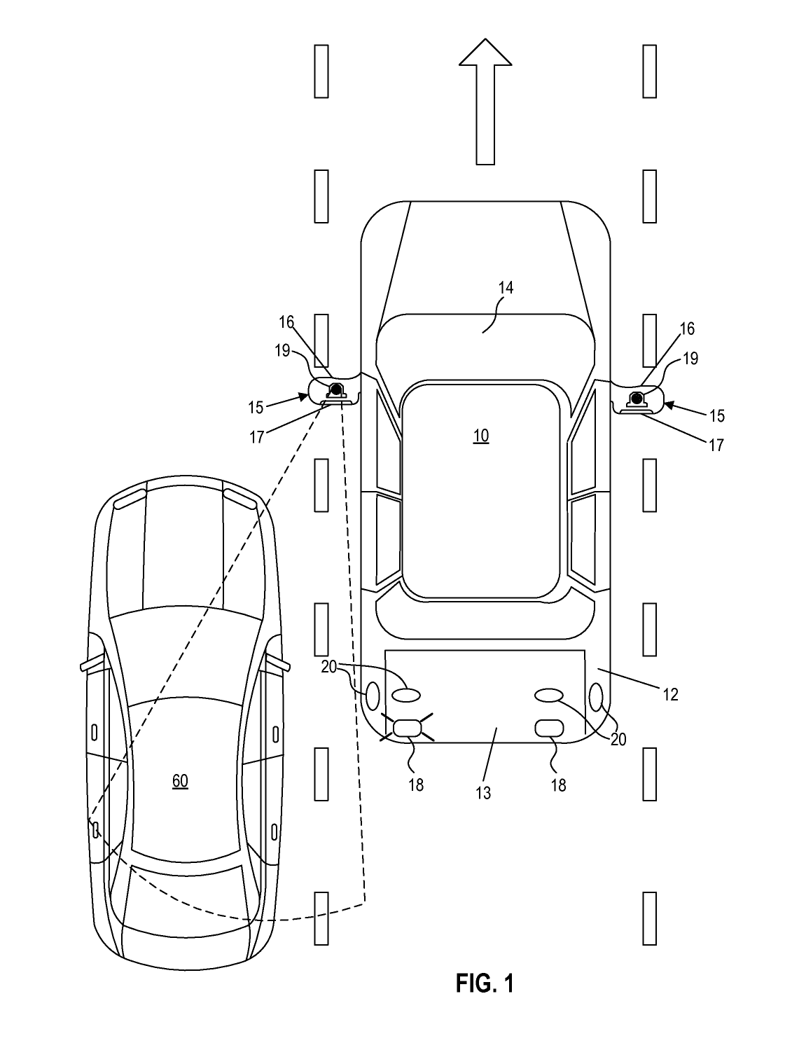

FIG. 1 provides an overhead illustration of an exemplary vehicle 10 according to an exemplary embodiment. As illustrated in FIG. 1, vehicle 10 may include, among other things, one or more side panels 12, a trunk lid 13, a windshield 14, and rear side-view mirrors 15. Each side-view mirror 15 may include a housing 16 and a mirror 17 to provide the driver visibility of another vehicle 60 in an adjacent lanes. Vehicle 10 may also include turn signals 18 that indicate certain actions of vehicle 10. For example, turn signals 18 may illuminate when vehicle 10 is breaking and may flash when vehicle 10 is either turning onto a cross-street or changing lanes. It is contemplated that vehicle 10 may be an electric vehicle, a fuel cell vehicle, a hybrid vehicle, or a conventional internal combustion engine vehicle. Vehicle 10 may have any body style, such as a sports car, a coupe, a sedan, a pick-up truck, a station wagon, a sports utility vehicle (SUV), a minivan, or a conversion van. Vehicle 10 may be configured to be operated by a driver occupying vehicle 10, remotely controlled, and/or autonomous.

Vehicle 10 may also have various electronics installed thereon to transmit and receive data related to conditions exterior to vehicle 10. For example, vehicle 10 may include one or more cameras 19 configured to capture video and/or images of an exterior to vehicle 10. Vehicle 10 may also include a number of object sensors 20 configured to detect objects positioned around vehicle 10.

Cameras 19 may include any device configured to capture video and/or images. For example, cameras 19 may include a wide-angled lens to enhance the field of view exterior to vehicle 10. Cameras 19 may provide night-vision and/or long-exposure to allow visibility of objects in low light. Cameras 19 may, additionally or alternatively, be configured to be adjustable in at least one of the vertical and/or lateral planes. Cameras 19 may also be configured to change a focal point depending on the distance of the objects. In some embodiments, cameras 19 may be used in conjunction with image recognition software and may be configured to detect motion. Cameras 19 may be configured to auto-adjust and/or auto-focus to capture video or images of detected objects. For example, cameras 19 may be configured to rotate laterally to capture video and/or images of another vehicle 60 that is passing (or being passed by) vehicle 10. Cameras 19 may also be configured to rotate in a vertical plane to capture an image of a pothole. A first camera 19 may be configured to generate a first signal based on captured video and/or images, and a second camera 19 may be configured to generate a second signal based on captured video and/or images.

Cameras 19 may be positioned at a variety of different locations on vehicle 10. As illustrated in FIG. 1, cameras 19 may be supported by side-view mirrors 15. For example, a first camera 19 may be supported by side-view mirror 15 on a left-hand side of vehicle 10, and a second camera 19 may be supported by side-view mirror 15 on a right-hand side of vehicle 10. In some embodiments, cameras 19 may be positioned on top or underneath of each housing 16, and/or on a face of each mirror 17. Cameras may be positioned rearward and/or forward to capture video and/or images of the environment exterior to vehicle 10. It is contemplated that cameras 19 may be releasably attached to or embedded into each of housing 16 and/or mirror 17. However, cameras 19 may also be positioned on side panel 12, trunk lid 13, or a bumper of vehicle 10. For example, cameras 19 may be positioned on side panel 12 adjacent the blind spot. Cameras 19 may be directed in any other direction to capture video and/or images relevant to vehicle 10.

Object sensors 20 may be positioned anywhere on vehicle 10 to detect whether an object is within proximity of vehicle 10. Object sensor 20 may be inductive, capacitive, magnetic, or any other type of sensor that is configured to generate a signal indicative of the presence and location of an object. Object sensors 20 may be positioned on side panel 12, trunk lid 13, and/or a back bumper to provide the driver an indication of objects that are not readily visible. For example, as illustrated in FIG. 1, vehicle 10 may include one or more object sensors 20 positioned on each side panel 12 to detect objects positioned on each side of vehicle 10, and one or more object sensors 20 positioned on trunk lid 13 to detect objects behind vehicle 10. It is also contemplated that object sensors 20 may, additionally or alternatively, be located on a rear bumper of vehicle 10. In some embodiments, object sensors 20 may be configured to be actuated based on an input from the driver, for example, to determine the locations of another vehicle 60 when vehicle 10 is changing lanes. In other embodiments, object sensors 20 may be configured to continuously monitor the areas surrounding vehicle 10 and may notify the driver whenever another vehicle 60 is within a blind spot. It is also contemplated that the signal generated by object sensor 20 may be configured to actuate cameras 19.

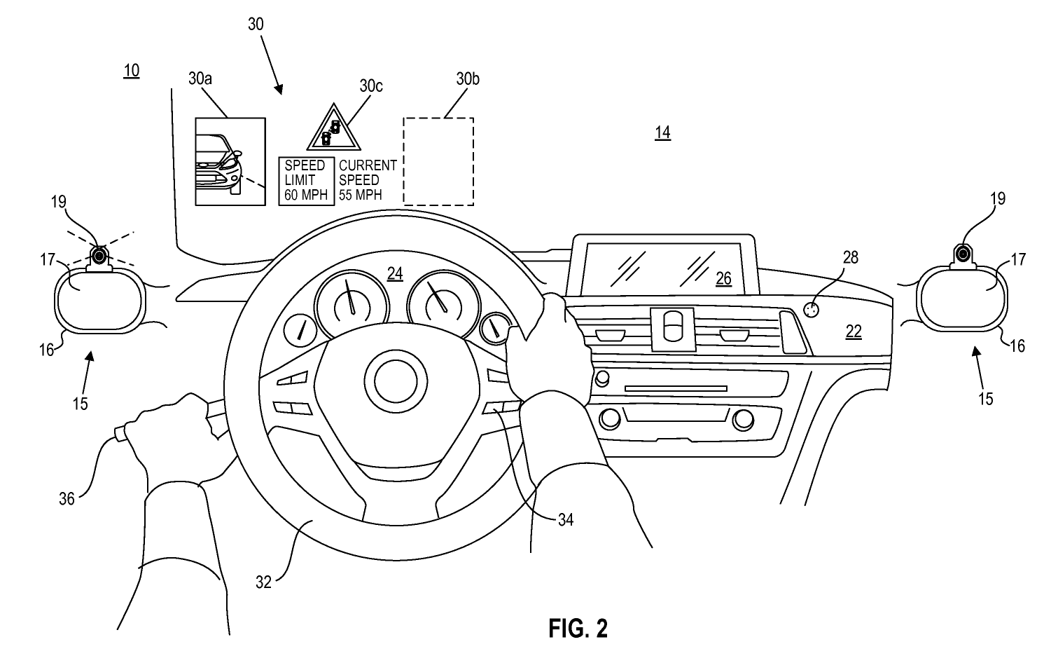

FIG. 2 is a diagrammatic illustration of an exemplary embodiment of an interior of exemplary vehicle 10. As illustrated in FIG. 2, vehicle 10 may include, among other things, a dashboard 22 that may house or embed an instrument panel 24, a user interface 26, and a microphone 28. Vehicle 10 may also include a head-up display (HUD) 30 projected onto windshield 14. Vehicle 10 may further include a steering wheel 32, at least one control interface 34, and a manual control 36, which may be manipulated by a driver.

According to some embodiments, manual control 36 may be configured to receive a user input and indicate a vehicle operation through turn signals 18. For example, if the driver moves manual control 36 in a first direction (e.g., by depressing manual control 36), a left turn signal 18 may illuminate, and if the driver moves manual control 36 in a second direction (e.g., by raising manual control 36), a right turn signal 18 may illuminate, or vice versa. It also is contemplated that turn signal 18 may provide different indications depending on the user input. For example, if the driver depresses/raises the manual control 36 to a certain extent, the respective turn signal 18 may blink for a few seconds to indicate that the driver intends to change lanes. However, if the driver depresses/raises manual control 36 more drastically (e.g., past a detent or to a stop), the respective turn signal 18 may blink for a longer period of time to indicate that the driver intends to make a turn, for example, onto a cross-street.

HUD 30 may be pre-installed into vehicle 10, housed or embedded into dashboard 22. In other embodiments, HUD 30 may be a separate component positionable on a top surface of dashboard 22. For example, HUD 30 may be secured with a releasable adhesive, a suction cup, or the like. HUD 30 may be positioned substantially aligned with steering wheel 32 to allow the driver to visualize the data without having to redirect the driver's sightline.

HUD 30 may be configured to project text, graphics, and/or images onto windshield 14 to provide the driver a vast amount of information pertaining to the driver and/or vehicle 10. HUD 30 may be configured to display turn-by-turn directions to the driver and speed limits. HUD 30 may also include one or more indicators 30c to warn the driver of hazards, such as another vehicle 60 in a blind spot, traffic, road construction, or required maintenance of vehicle 10. HUD 30 may also be configured to mirror data from at least one of instrument panel 24, user interface 26, and a stereo system. For example, HUD 30 may be configured to display the speedometer of vehicle 10 or other conditions, such as battery level, fuel level, water level, and engine speed. According to some embodiments, one or more of the types and/or conditions may be displayed adjacent one another, and/or may be superimposed relative to one another.

HUD 30 may also be configured to display video and/or images captured by cameras 19. The video and/or images may be projected on the respective side of the side-view mirror 15. For example, if the video and/or images are captured from camera 19 on the left side of vehicle 10, the video and/or images may be projected on a left display area 30a of HUD 30. Similarly, if video and/or images are captured from camera 19 on the right side, the video and/or images may be projected on a right display area 30b of HUD 30. This may favorably orient the driver, while not requiring the driver to redirect the driver's sightline. It is also contemplated that the video and/or images may be displayed for the length of a signal generated. For example, the video and/or images may be displayed for the length that manual control 36 is depressed. Alternatively, the video and/or images may be displayed only for a short predetermined period of time (e.g., a few seconds). For example, when the driver actuates manual control 36 in an attempt to change lanes, the video and/or images may be displayed for about the same length of time that turn signal 18 may blink. This may provide the driver sufficient information, while reducing the distraction. In some embodiments, the video and/or images may only be displayed if certain additional conditions are met. For example, when the driver actuates manual control 36 in an attempt to change lanes, the video and/or images may only be displayed if it is determined that an object is in the prospective lane within proximity of vehicle 10. This may be advantageous in that the driver may not necessarily need the side-view while changing lanes unless there is an object that may be of concern.

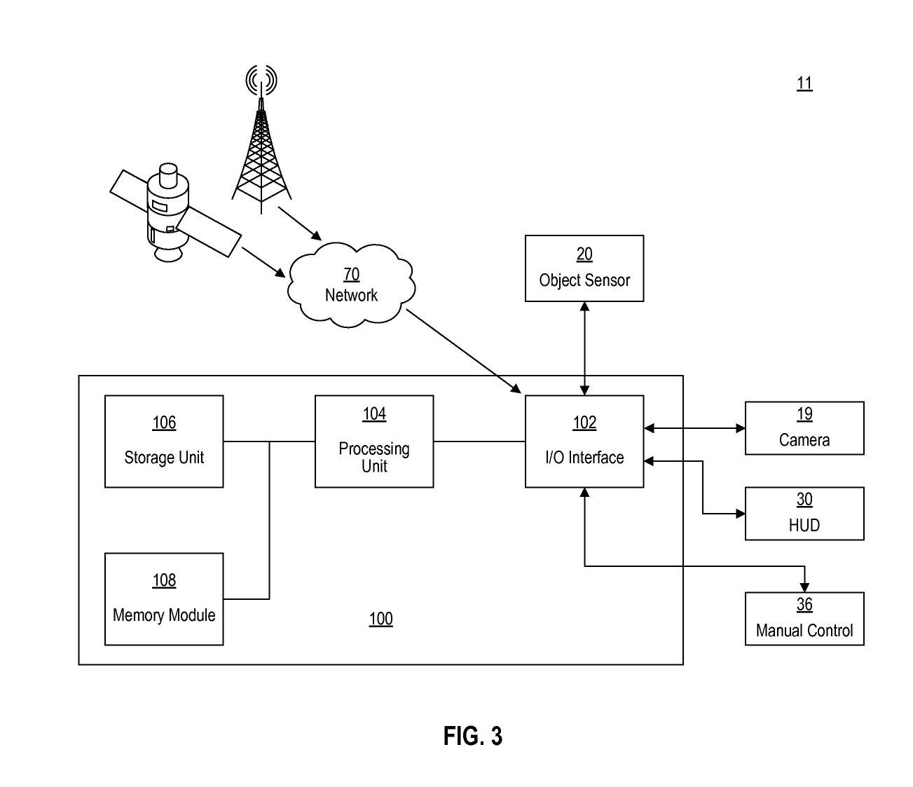

FIG. 3 provides a block diagram of an exemplary camera system 11 that may be used in accordance with a method of displaying an exterior to vehicle 10. As illustrated in FIG. 3, camera system 11 may include a controller 100 having, among other things, an I/O interface 102, a processing unit 104, a storage unit 106, and a memory module 108. These units may be configured to transfer data and send or receive instructions between or among each other.

I/O interface 102 may also be configured for two-way communication between controller 100 and various components of camera system 11. For example, as depicted in FIG. 3, I/O interface 102 may send and receive operating signals to and from cameras 19, object sensor 20, HUD 30, and/or manual control 36. I/O interface 102 may send and receive the data between each of the components via communication cables, wireless networks, or other communication mediums. I/O interface 102 may also be configured to receive data from satellites and radio towers through network 70. For example, I/O interface 102 may be configured to receive road maps, traffic data, and/or driving directions. Processing unit 104 may be configured to receive signals from components of camera system 11 and process the signals to determine a plurality of conditions of the operation of vehicle 10. Processing unit 104 may also be configured to generate and transmit command signals, via I/O interface 102, in order to actuate the components of camera system 11.

Processing unit 104 may be configured to determine the presence of objects around vehicle 10. In some embodiments, processing unit 104 may be configured to receive a signal generated by object sensors 20 to determine the presence of objects within proximity of vehicle 10. Processing unit 104 may also be configured to execute image recognition software to process videos and/or images captured by cameras 19. For example, processing unit 104 may be configured to distinguish and locate another vehicle 60, lane patterns, upcoming road hazards, potholes, construction, and/or traffic. Processing unit 104 may be configured to locate another vehicle 60 in adjacent lanes and determine the distance and speed of other vehicles 60. Processing unit 104 may further be configured to determine whether the presence of the other vehicles 60 is making the vehicle operation unsafe. For example, processing unit 104 may be configured to determine whether another vehicle 60 is in the driver's blind spot or whether another vehicle 60 is fast approaching in the adjacent lane.

Processing unit 104 may also be configured to responsively generate text, graphics, and/or images to HUD 30 depending on the vehicle operation and/or the location and speed of objects exterior to vehicle 10. In some embodiments, processing unit 104 may be configured to display video and/or an image whenever camera system 11 determines that an object (e.g., another vehicle 60) is within a predetermined proximity of vehicle 10. For example, processing unit 104 may be configured to display a video captured by cameras 19 whenever another vehicle 60 is positioned in a blind spot. This may make the driver aware of another vehicle 60, which may be especially important when the driver performs lane changes without actuating manual control 36. In some embodiments, processing unit 104 may be configured to display video and/or images whenever camera system 11 receives an input indicative of a vehicle operation (e.g., changing lanes). For example, based on depressing/raising manual control 36, processing unit 104 may be configured to output video captured from camera 19 on the left side of vehicle 10 to left display area 30a of HUD 30. Similarly, for example, if processing unit 104 may be configured to output video captured from camera 19 on the right side of vehicle 10 to right display area 30b of HUD 30. However, in some embodiments, processing unit 104 may be configured to display video and/or images only, for example, when camera system 11: 1) receives an input indicative of a vehicle operation and 2) an object is within a predetermined proximity of vehicle 10. For example, processing unit 104 may only display a video to one of display areas 30a, 30b after 1) receiving a signal from manual control 36 indicative of a vehicle operation (e.g., changing lanes), and 2) cameras 19, and/or object sensors 20 determining that another vehicle 60 is within certain proximity of vehicle 10 while performing the vehicle operation.

Processing unit 104 may also be configured to display a first output based on a first set of conditions, and a second output based on a more urgent second set of conditions. For example, HUD 30 may be configured to display video of another vehicle 60 in an adjacent lane when another vehicle 60 is within 100 feet, and vehicle 10 and another vehicle 60 are both traveling at least 55 miles per hours (MPH). Processing unit 104 may further be configured to output a more urgent indication when there is an object that may be potentially hazardous to vehicle 10 when conducting the vehicle operation. For example, HUD 30 may additionally display indicator 30c when camera system 11 determines that another vehicle 60 is within a blind spot of vehicle 10. Other contemplated hazard indications may include displaying the video to display areas 30a, 30b in colors of a redscale, outlining display areas 30a, 30b in red, and/or outputting an audible signal through speakers of vehicle 10.

It is also contemplated that processing unit 104 may be configured to process video and/or images received by cameras 19 to determine the current lane of vehicle 10, and receive road maps through network 70 to determine the exact location of vehicle 10. Processing unit 104 may then be configured to compare the desired vehicle operation to the road maps and/or traffic conditions received through network 70, and determine the impact of the desired vehicle operation. For example, processing unit 104 may be configured to receive an indication of a lane change and determine whether the prospective lane is ending in a certain distance or whether the prospective lane is an exit-only lane. Processing unit 104 may then be configured to output an indicator through HUD 30, such as “CHANGING INTO EXIT LANE.” Processing unit 104 may also be configured to determine traffic conditions or road construction in the prospective lane through network 70. Processing unit 104 may then be configured to output an indicator such as “TRAFFIC AHEAD IN PROSPECTIVE LANE” after it receives an indication of a lane change. Similar determinations may be made when camera system 11 receives an indication of a turn onto a cross-street.

Processing unit 104 may be further configured to provide turn-by-turn directions based on the current lane location. For example, based on images generated by cameras 19, processing unit 104 may be configured to determine that vehicle 10 is in a center lane and needs to change into the left lane to enter an exit ramp to reach a destination. Processing unit 104 may then display an indicator through HUD 30, such as “CHANGE INTO LEFT LANE.” Further, based on input from the driver, processing unit 104 may be configured to determine if a prospective vehicle operation is consistent with the turn-by-turn directions. For example, after receiving a signal from manual control 36 indicating that the driver wants to change into a right lane, processing unit 104 may be configured to determine if changing into the right lane is consistent with the pending turn-by-turn directions. If an inconsistency is determined, processing unit 104 may be configured to output a warning or corrective measures to the driver.

Storage unit 106 and memory module 108 may include any appropriate type of mass storage provided to store any type of information that processing unit 104 may use to operate. For example, storage unit 106 may include one or more hard disk devices, optical disk devices, or other storage devices to provide storage space. Memory module 108 may include one or more memory devices including, but not limited to, a ROM, a flash memory, a dynamic RAM, and a static RAM.

Storage unit 106 and/or memory module 108 may be configured to store one or more computer programs that may be executed by controller 100 to perform functions of camera system 11. For example, storage unit 106 and/or memory module 108 may be configured to store image recognition software configured to detect objects (e.g., other vehicles 60) and determine a position and a speed of the objects. Storage unit 106 and/or memory module 108 may be further configured to store data and/or look-up tables used by processing unit 104. For example, storage unit 106 and/or memory module 108 be configured to include data related to required distances of vehicle 10 when changing lanes based on a speed.

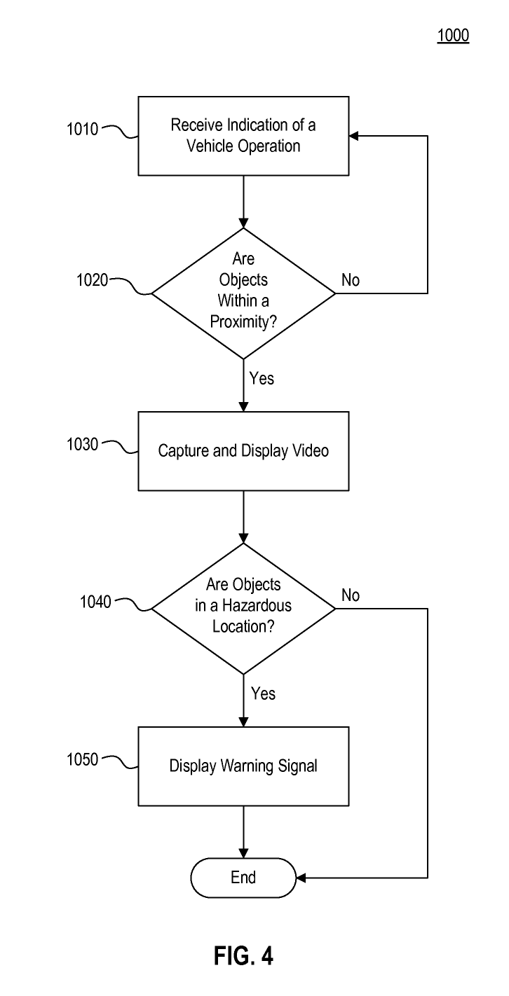

FIG. 4 illustrates an exemplary method 1000 performed by camera system 11. Exemplary operations of camera system 11 will now be described with respect to FIG. 4.

Method 1000 may begin at Step 1010, where controller 100 receives an indication of a vehicle operation. The user input may be a signal generated by at least one of microphone 28, control interface 34, and/or manual control 36. For example, the signal may be generated by the driver raising or depressing manual control 36 or actuating control interface 34 to indicate an operation of vehicle 10. The indication of vehicle operation may also be based on voice commands via microphone 28. The vehicle operation may be based on vehicle 10 changing lanes, or may be based on vehicle 10 making a turn onto a cross-street. Step 1010 may alternatively be based on the driver actuating cameras 19 independent of a vehicle operation. For example, Step 1010 may be based on voice commands from the driver requesting video of the blind spot(s) of vehicle 10.

In Step 1020, one or more components of camera system 11 may determine whether there are any objects within a proximity of vehicle 10. This determination may be made by cameras 19 and/or object sensors 20. In some embodiments, controller 100 may actuate cameras 19 to capture an initial image of the area exterior to vehicle 10, and controller 100 may then execute image recognition software to detect objects. Controller 100 may recognize objects in the initial image, such as another vehicle 60. Controller 100 may also detect properties of another vehicle 60, such as relative distance and speed, and determine the location of another vehicle 60 when vehicle 10 changes lanes. In some embodiments, the determination may be made according to signals generated by object sensors 20. If it is determined that another vehicle 60 is sufficiently close to vehicle 10 when changing lanes (Yes; Step 1020), controller 100 may proceed to Step 1030. Step 1020 may limit distraction to the driver, for example, by only displaying video and/or images when an object is sufficiently close to vehicle 10. However, in some embodiments, Step 1020 may be omitted, such that controller 100 may capture and display video and/or images whenever controller 100 receives an indication of a vehicle operation according to Step 1010.

In Step 1030, cameras 19 of camera system 11 may capture and display video and/or images. Cameras 19 may auto-adjust and/or auto-focus to better capture objects surrounding vehicle 10. In some embodiments, cameras 19 may capture and display video and/or images for the entire time that vehicle 10 is performing an operation. For example, camera system 11 may display video the entire time that vehicle 10 is changing lanes. In some embodiments, cameras 19 may capture and display video and/or images for a predetermined time after controller 100 receives the input. For example, controller 100 may actuate cameras 19 for a short time (e.g., five seconds) to minimize driver distraction.

In Step 1040, one or more components of camera system 11 may determine whether the object is in a location potentially hazardous to vehicle 10 when conducting the vehicle operation, such as changing lanes. In some embodiments, controller 100 may process an image from camera 19 to determine whether another vehicle 60 is within a blind spot or fast approaching vehicle 10, such that the vehicle operation of vehicle 10 may substantially obstruct another vehicle 60. In some embodiments, controller 100 may process a signal generated by object sensors 20. Step 1040 may have a higher threshold than Step 1020, such that the determination in Step 1040 may be based on the object being closer than determined in Step 1020. For example, Step 1040 may be determined based on whether one of vehicle 10 and/or another vehicle 60 would need to substantially change course and/or speed in order to avoid an accident. If controller 100 determines that the object is in a location potentially hazardous to vehicle 10 (Yes; Step 1040), controller 100 may proceed to Step 1050.

In Step 1050, one or more components of camera system 11 may display a warning signal. In some embodiments, HUD 30 may display indicator 30c when camera system 11 determines that another vehicle 60 is within a blind spot of vehicle 10. Other contemplated hazard indications may include displaying the video of display areas 30a, 30b in a red-scale, outlining display areas 30a, 30b in red, and/or outputting an audible signal through speakers of vehicle 10.

Another aspect of the disclosure is directed to a non-transitory computer-readable medium storing instructions which, when executed, cause one or more processors to perform the method of displaying an area exterior to a vehicle, as discussed above. The computer-readable medium may include volatile or non-volatile, magnetic, semiconductor, tape, optical, removable, non-removable, or other types of computer-readable medium or computer-readable storage devices. For example, the computer-readable medium may be storage unit 106 or memory module 108 having the computer instructions stored thereon, as disclosed in connection with FIG. 3. In some embodiments, the computer-readable medium may be a disc or a flash drive having the computer instructions stored thereon.

It will be apparent to those skilled in the art that various modifications and variations can be made to the disclosed camera system and related methods. Other embodiments will be apparent to those skilled in the art from consideration of the specification and practice of the disclosed camera system and related methods. It is intended that the specification and examples be considered as exemplary only, with a true scope being indicated by the following claims and their equivalents.

What is claimed is:

1. A camera system for a vehicle, the camera system comprising:
a manual control configured to receive a first input from an occupant indicative of a first vehicle operation and responsively generate a first signal;
a first turn signal configured to illuminate;
a first camera configured to capture video of a first area exterior to the vehicle;
a display configured to output video; and
a controller in communication with the manual control, the first turn signal, the first camera, and the display, the controller being configured to:
receive the first signal from the manual control;
actuate the first turn signal to illuminate based on the first signal;
actuate the first camera to capture a first video based on the first signal;
output the first video to the display based on the first signal.

2. The camera system of claim 1, further comprising:
a second turn signal configured to illuminate; and
a second camera configured to capture video of a second area exterior to the vehicle,
wherein the manual control is further configured to receive a second input from the occupant indicative of a second vehicle operation and responsively generate a second signal, and
wherein the controller is in communication with the second turn signal and the second camera, the controller being further configured to:
receive the second signal from the manual control;
actuate the second turn signal to illuminate based on the second signal;
actuate the second camera to capture a second video based on the second signal;
output the second video to the display based on the second signal.

3. The camera system of claim 2,
wherein the manual control includes a lever, and
wherein the first input is based on moving the lever in a first direction, and the second input is based on moving the lever in a second direction.

4. The camera system of claim 2,
wherein the display includes a first viewing area and a second viewing area different from the first viewing area, and
wherein the controller is configured to output the first video to the first viewing area based on the first signal and output the second video to the second viewing area based on the second signal.

5. The camera system of claim 1,
wherein the display includes a head-up display, and
wherein the controller is configured to output the first video to the head-up display.

6. The camera system of claim 1, wherein the controller is configured to display the video for a pre-determined time period.

7. The camera system of claim 1, wherein the controller is further configured to:
determine whether an object is within a proximity of the vehicle, and
actuate the first camera further based on the determination of the object within the proximity of the vehicle.

8. The camera system of claim 1, wherein the first camera is configured to be automatically adjusted based on perceived objects.

9. The camera system of claim 1, wherein the first camera is configured to be positioned on a rear side-view mirror of the vehicle.

10. A method of displaying an area exterior to a vehicle, the method comprising:
receiving a first input with a manual control indicative of a first vehicle operation and responsively generating a first signal;
actuating a first turn signal based on the first input;
actuating a first camera to capture a first video of a first area exterior to the vehicle based on the first signal; and
outputting the first video to the display based on the first signal.

11. The method of claim 10, further including:
receiving a second input with the manual control indicative of a second vehicle operation and responsively generating a second signal;
actuating a second turn signal based on the second signal;
actuating a second camera to capture a second video of a second area exterior to the vehicle based on the second signal; and
outputting the second video to the display based on the second signal.

12. The method of claim 11, further including:
moving the manual control in a first direction to generate the first input; and
moving the manual control in a second direction to generate the second input,
wherein the manual control includes a lever.

13. The method of claim 11, wherein the displaying includes outputting the first video to a first viewing area based on the first signal, and outputting the second video to a second viewing area different from the first viewing area based on the second signal.

14. The method of claim 10, further including projecting the display on a windshield of the vehicle.

15. The method of claim 10, further including displaying the video for a pre-determined time period.

16. The method of claim 10, further including:
determining whether an object is within a proximity of the vehicle, and
wherein the actuating the first camera is further based on the determination of the object within the proximity of the vehicle.

17. The method of claim 16, further including outputting a warning signal based on the determination of the object.

18. The method of claim 10, further including automatically adjusting the first cameras based on perceived objects.

19. A vehicle configured to be operated by an occupant comprising:
a camera system including:
a manual control configured to receive an input from an occupant indicative of a vehicle operation and responsively generate a signal;
a turn signal configured to illuminate;
a camera configured to capture video of an area exterior to the vehicle;
a display configured to output video; and
a controller in communication with the manual control, the turn signal, the camera, and the display, the controller being configured to:
receive the signal from the manual control;
actuate the turn signal to illuminate based on the signal;
actuate the camera to capture a video based on the signal;
output the video to the display based on the signal.

20. A non-transitory computer-readable medium storing instructions which, when executed, cause one or more processors to perform a method of displaying an area exterior to a vehicle, comprising:
receiving an input with a manual control indicative of a vehicle operation and responsively generating a signal;
actuating a turn signal based on the signal;
actuating a camera to capture a video of an area exterior to the vehicle based on the signal; and
outputting the video to the display based on the signal.
